(19) United States
(12) Patent Application Publication
(10) Pub. No.: US 2015/0075319 A1
(43) Pub. Date: Mar. 19, 2015

(54) TIMING PIN MODULE FOR USE ON AN ENGINE DURING SERVICE

(71) Applicant: Caterpillar Inc., Peoria, IL (US)

(72) Inventors: GNANASEKAR JEEVANANTHAM, CHENNAI (IN); ANUPAM RADHAKRISHNAN, NORMAL, IL (US); RAJESH SAMPATH, CHENNAI (IN); SIVAKUMAR RAMAIYAN, CHENNAI (IN)

(73) Assignee: Caterpillar Inc., Peoria, IL (US)

(21) Appl. No.: 14/549,572

(22) Filed: Nov. 21, 2014

(51) Int. Cl. F02B 77/08

(52) U.S. Cl. CPC F02B 77/087
USPC 74/527

(57) ABSTRACT

A timing pin module for an engine is disclosed herein. The timing pin module includes a mount end, an engagement end, an adapter, a pin, and a resilient member. The adapter, with a through hole is disposed on the mount end and is mountable to the housing cover. The pin has a longitudinal axis, a first end disposed on the engagement end, and a second end disposed on the mount end. The pin is slideably disposed in the through hole of the adapter and moves between an extended position and a retracted position. The resilient member has a first end engaged with the pin and a second end engaged with the adapter. Further, the first end of the pin engageably retains the flywheel in the top dead center position while extended, and makes sliding contact with a portion of the flywheel that is in the retracted position.

### TECHNICAL FIELD

The present disclosure relates generally to the timing of an engine. More specifically, the present disclosure relates to a timing pin module for use to establish top dead center in preparation for servicing an engine.

### BACKGROUND

Engines are commonly known to include valves, a crankshaft, a flywheel, and an outer cover. During service and/or repair of an engine, the valves are required to be adjusted relative to an angular orientation of the crankshaft, for proper operation of the valves. This process that adjusts the valves relative to the angular orientation of the crankshaft is termed as the “timing” of the engine. While the engine is timed, the crankshaft and the flywheel are locked in a particular orientation (generally the top dead center position) so that the valves are adjusted relative to that particular orientation of the crankshaft. A timing pin module is generally used as a tool to fix the orientation of the flywheel of the engine with the block or fixed shroud which coincides with the top dead center position of the engine. The timing pin module is positioned within the outer cover and is made to pass through an aperture in the flywheel to position the flywheel which in turn positions the engine crank at top dead center. By this means, the crankshaft is positioned in the top dead center position.

Conventionally, the timing pin module is positioned proximal to various other components of the engine, such as an electronic control module (ECM), and/or a dipstick. Due to space limitations and lengthy size of the timing pin module, certain components must be disassembled from the engine, such as the dipstick and/or ECM, before the timing pin module is installed. This increases service time and rework for an operator servicing the engine. This results in increased service cost.

United States Patent, U.S. Pat. No. 5,440,947 discloses a timing pin apparatus to lock a flywheel of an engine with a bell housing of the engine. The timing pin apparatus includes a pin, a first spring means to bias the pin in a first direction, and a second spring means to bias the pin in a second direction. The first and second spring means are arranged linearly and form a lengthy arrangement. Moreover, since this mechanism is designed to stay in place and be retracted when service is complete however if this mechanism is triggered during operation of the machine, as a result, damage to the engine and this device is likely. What is needed is a timing pin apparatus to cost effectively position the flywheel with the housing of the engine, and to do so with little if any risk to the device triggering when the engine is in operation. The present disclosure provides a pin assembly that overcomes one or more of the aforementioned problems.

### SUMMARY OF THE INVENTION

Various aspects of the present disclosure are directed to a timing pin module for an engine. The timing pin module includes a mount end and an engagement end and designed to mount on the engine to establish a top dead center position of a crankshaft within the engine. The engine includes a housing cover and a flywheel. The housing cover of the engine has an aperture to receive the timing pin module. The flywheel has an aperture to receive the engagement end of the timing pin module to lock the flywheel and the crankshaft in the top dead center position as the flywheel is selectively rotated within the engine. The timing pin module includes an adapter, a pin, and a resilient member. The adapter is disposed on the mount end of the timing pin module and includes a through hole. The adapter being mountable to the housing cover of the engine within the aperture of the housing cover. The pin includes a longitudinal axis, a first end disposed on the engagement end of the timing pin module, and a second end disposed on the mount end of the timing pin module. The pin being slideably disposed within the through hole of the adapter and being adapted to move between a retracted position and an extended position. The pin having a flywheel retention portion disposed on the first end of the pin. The resilient member having a first end engaged with the pin and a second end in engagement with the adapter. The first end of the pin being urged away from the adapter through the resilient member. Further, the first end of the pin engageably retains the flywheel through the aperture in the flywheel to establish the top dead center position of the crankshaft coinciding with the pin being in the extended position. Moreover, the first end of the pin being urged in slidable contact with a portion of the flywheel by the resilient member coinciding with the pin being in the retracted position in response to selective rotation of the flywheel and the flywheel and crankshaft not in the top dead center position.

### BRIEF DESCRIPTION OF THE DRAWINGS

FIG. 1 is a partial perspective view of an engine showing a housing cover, a flywheel, and a timing pin module, the housing cover and the timing pin module in section according to the present disclosure;

FIG. 2 is a perspective view of the timing pin module of FIG. 1 illustrating various components of the timing pin module;

FIG. 3 is an exploded view of the timing pin module of FIG. 2 illustrating the structure and arrangement of various components of the timing pin module;

FIG. 4 is an enlarged sectional view of the timing pin module and surrounding portions of the engine as shown in FIG. 1, illustrating the timing pin module in a retracted position relative to the flywheel of the engine; and

FIG. 5 is an enlarged sectional view of the timing pin module and surrounding portions of the engine as shown in FIG. 1, illustrating the timing pin module in an extended and engaged position relative to the flywheel of the engine.

### DETAILED DESCRIPTION

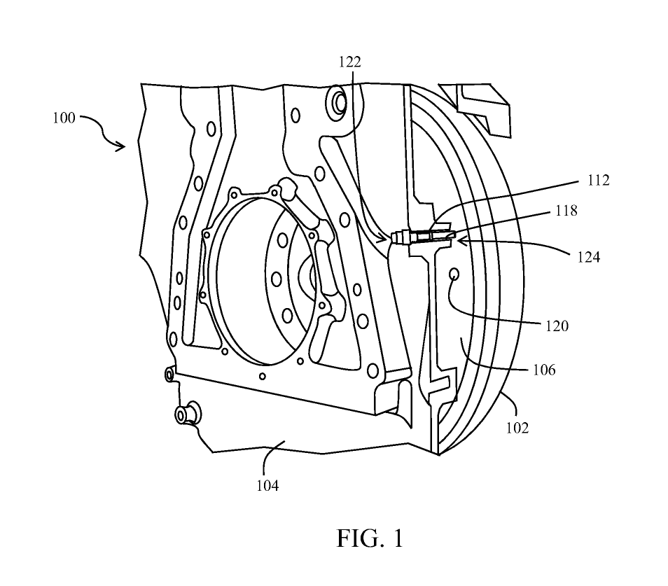

Referring to FIG. 1, there is shown an internal combustion engine 100 for use to power a machine or generator. The machine may embody a construction machine, a forest machine, a marine machine, a stationary machine, and/or any other similar machine. The engine 100 commonly includes a crankshaft (not shown), a flywheel 102, and a housing cover 104.

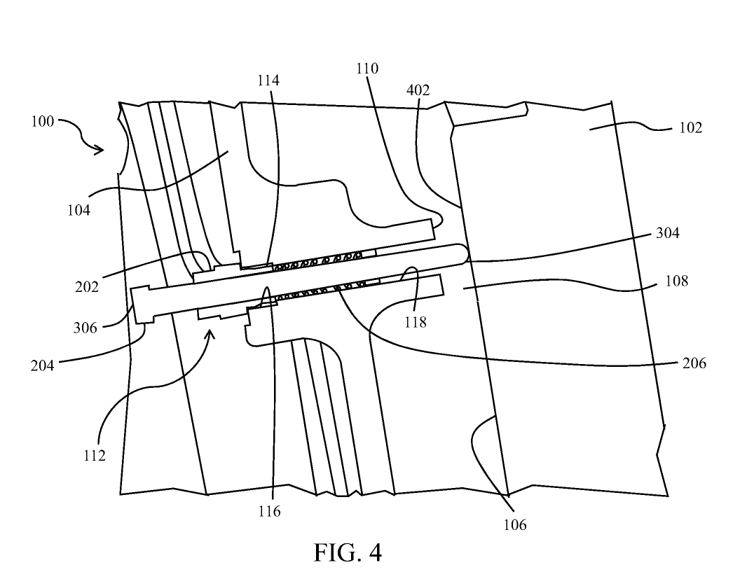

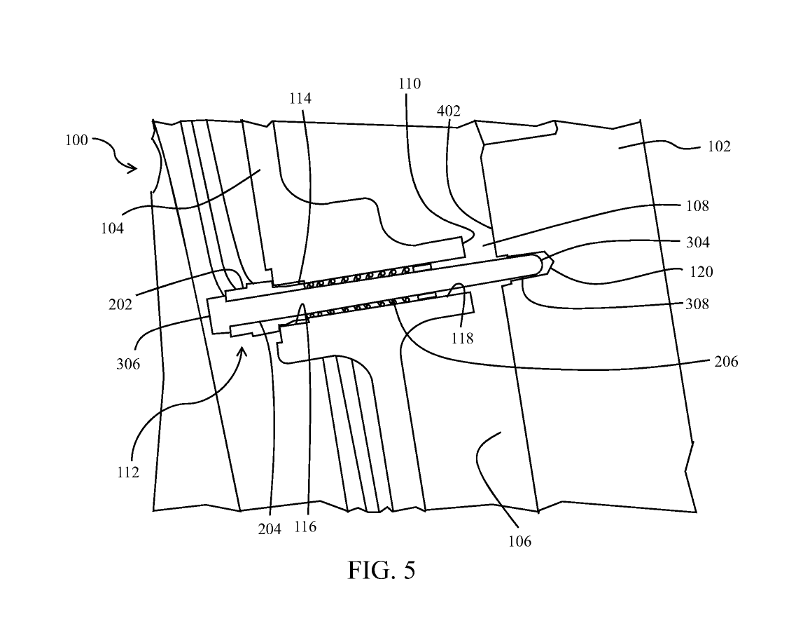

The crankshaft (not shown) and the flywheel 102 are suitably arranged with other components of the engine 100 to efficiently run the engine 100, as is customary. The housing cover 104 is a stationary housing of the engine 100 and is adapted to generally cover and protect the flywheel 102. However, it will be understood that the present disclosure contemplates that a portion of the posterior of the engine block which overlays the flywheel 102, or a flange which is bolted to the engine block to overly the flywheel 102 may also be defined as the housing cover 104 to suitably receive a timing pin module 112 therein as will be further described below. More specifically, the housing cover 104 overlays the flywheel 102, albeit gap 108 exists between a pin-facing surface 106 of the flywheel 102 and an inner portion 110 of housing cover 104 (FIGS. 4-5).

Furthermore, the crankshaft (not shown) and the flywheel 102 may require to be specifically oriented and even locked to the housing cover 104 to ensure the engine 100 is in a top dead center position to properly initiate timing of the engine 100. Therefore, during non-operation, a timing pin module 112 may be installed on the engine 100, to lock the flywheel 102 and the crankshaft (not shown) in the top dead center position to initiate setting the timing of the engine 100. More specifically, the housing cover 104 of the engine 100 includes an aperture 118, to receive the timing pin module 112. As best seen in FIGS. 4-5, the timing pin module 112 includes an adapter 202 having an external threaded portion 114 which is designed to extend into aperture 118 and thread directly with internal threaded portion 116 of housing cover 104. The flywheel 102 of the engine 100 also includes an aperture 120, in the pin-facing surface 106 of the flywheel 102. The aperture 120 of the flywheel 102 is positioned so that the crankshaft (not shown) is in the top dead center position when the aperture 120 of the flywheel 102 faces the aperture 118 of the housing cover 104.

The timing pin module 112 is designed to mount on the engine 100, and to establish the top dead center position of the crankshaft (not shown) and the flywheel 102, within the engine 100. The timing pin module 112 may be installed in the aperture 118 of the housing cover 104, and faces the pin-facing surface 106 of the flywheel 102. The timing pin module 112 includes a mount end 122 and an engagement end 124. The mount end 122 may be fixedly positioned in the aperture 118 of the housing cover 104 to mount the timing pin module 112 on to the engine 100. The engagement end 124 is resiliently positioned against the flywheel 102 of the engine 100. The engagement end 124 of the timing pin module 112 may be received by the aperture 120 of the flywheel 102 to lock the flywheel 102 in the top dead center position as the flywheel 102 is selectively rotated.

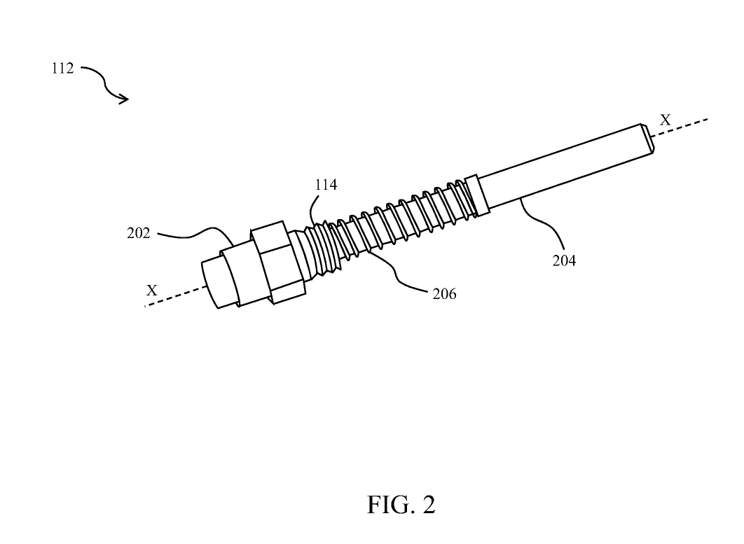

Referring to FIG. 2, there is shown the timing pin module 112. The timing pin module 112 may be safely kept in a tool box, and installed the engine 100, when required. More specifically, the timing pin module 112 is otherwise kept in the toolbox and mounted on the engine 100 to lock the flywheel 102, during servicing of the engine 100. The timing pin module 112 includes the adapter 202, a pin 204, and a resilient member 206. The adapter 202, the pin 204, and the resilient member 206, are arranged in a manner so that the pin 204 is movable between an extended position and a retracted position.

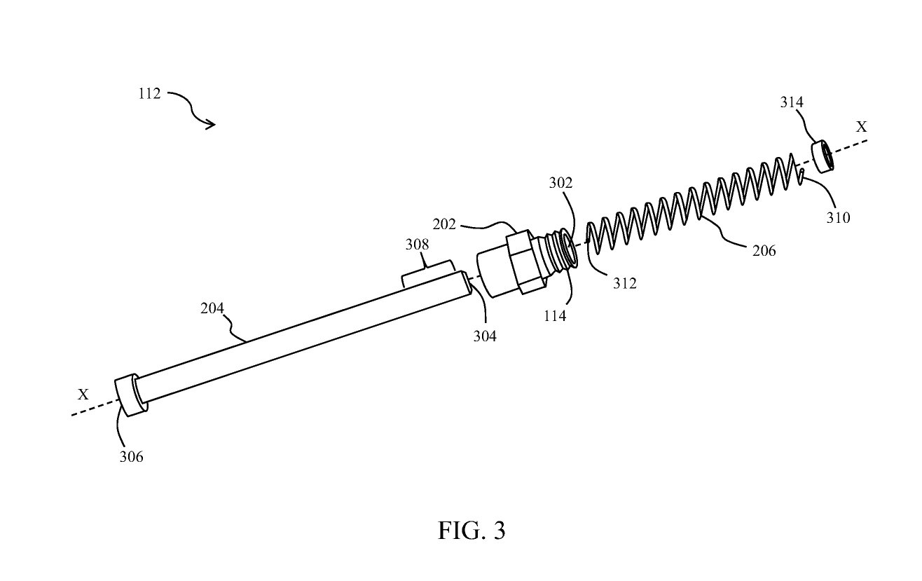

Referring to FIG. 3, there is shown the timing pin module 112 that illustrates the adapter 202, the pin 204, and the resilient member 206, of the timing pin module 112, in exploded form. The adapter 202 of the timing pin module 112, is a cylindrical guide-member disposed on the mount end 122 of the timing pin module 112. The adapter 202 may include a though hole 302 that slideably supports the pin 204 of the timing pin module 112. Further, the adapter 202 is mountable to the housing cover 104 of the engine 100, to mount the timing pin module 112 on the engine 100, when required. In assembly, the adapter 202 may be in threaded engagement with the aperture 118 of the housing cover 104. In this way, the timing pin module 112 may be mounted on to the engine 100.

The pin 204 is slideably disposed within the through hole 302 of the adapter 202. The pin 204 includes a first end 304, a second end 306, and a longitudinal axis X-X. The first end 304 of the pin 204 is disposed on the engagement end 124 of the timing pin module 112. The second end 306 of the pin 204 is disposed on the mount end 122 of the timing pin module 112. The pin 204 is adapted to resiliently move between the retracted position and the extended position along the longitudinal axis X-X. The pin 204 also includes a flywheel retention portion 308 along the first end 304. The flywheel retention portion 308 locks with the aperture 120 of the flywheel 102, in the extended position of the pin 204.

The resilient member 206, such as a spring member, is positioned to resiliently move the pin 204 between the retracted position and the extended position, along the longitudinal axis X-X. The resilient member 206 is axially aligned with the pin 204, and is disposed along a periphery of the pin 204. The resilient member 206 includes a first end 310 and a second end 312. The first end 310 of the resilient member 206 is in fixed engagement with the pin 204. The second end 312 of the resilient member 206 is in fixed engagement with the adapter 202. It may be noted that the first end 310 of the resilient member 206 is in fixed engagement with the pin 204, via a lock nut 314. More specifically, the lock nut 314 may be fixedly attached to an outer perimeter of the pin 204, while the first end 310 of the resilient member 206 is connected to the lock nut 314. It may be contemplated that the lock nut 314 is shown as independent of the pin 204. However, the lock nut 314 may be an integral component of the pin 204. The specific structure and arrangement of the adapter 202, the pin 204, and the resilient member 206 enables the first end 304 of the pin 204 to be urged away from the adapter 202.

Referring to FIG. 4, there is shown the timing pin module 112 mounted on the engine 100 while the pin 204 is in retracted position. The timing pin module 112 may be installed in the aperture 118 of the housing cover 104, along the adapter 202 of the timing pin module 112. More specifically, the adapter 202 is installed within the aperture 118 of the housing cover 104, to mount the timing pin module 112. When the flywheel 102 and the crankshaft (not shown) are not in the top dead center position, the pin 204 of the timing pin module 112, is in retracted position. In the retracted position, the first end 304 of the pin 204 is urged to be in sliding contact with a portion 402 of the flywheel 102, in response to a selective rotation of the flywheel 102.

Referring to FIG. 5, there is shown the timing pin module 112 mounted on the engine 100, while the pin 204 is in extended position. As noted above, the timing pin module 112 may be installed in the aperture 118 of the housing cover 104, along the adapter 202 of the timing pin module 112. As the flywheel 102 and the crankshaft (not shown) reach the top dead center position, the pin 204 moves to its extended position. In the extended position, the first end 304 of the pin 204 engageably retains the flywheel 102 through the aperture 120 in the flywheel 102. More specifically, the flywheel retention portion 308 of the pin 204 retains the flywheel 102 in the top dead center position.

### INDUSTRIAL APPLICABILITY

In operation, the engine 100 may routinely require service and/or repair. During service and/or repair, it may be required to lock the crankshaft (not shown) and the flywheel 102 in the top dead center position and then adjust intake and exhaust valves corresponding to the top dead center position. The timing pin module 112 is installed in the aperture 118 of the housing cover 104, to establish the top dead center position of the crankshaft (not shown) and the flywheel 102. It may be noted that the timing pin module 112 is otherwise safely kept in its unitary form in the tool box, when not being used. Since, the timing pin module 112 is safely kept in the tool box during normal operations of the engine 100, the timing pin module 112 does not experience any damage that may be likely to be caused by various other components of the engine 100.

The timing pin module 112 is installed along the adapter 202 of the timing pin module 112. More specifically, the adapter 202 may be mounted in the aperture 118 of the housing cover 104. Moreover, as the resilient member 206 is installed around the periphery of the pin 204, the timing pin module 112 is relatively compactly packed as compared to conventional timing pin modules. This enables the timing pin module 112 to be installed in the aperture 118 of the housing cover 104, without disassembling any other component (ECM and/or dipstick) of the engine 100. Thereby, the service cost and effort are highly reduced. More specifically, the specific compact design of the timing pin module 112 facilitates easy and quick installation of the timing pin module 112 on to the engine 100, thereby reducing the service cost.

Furthermore, as the timing pin module 112 is installed, the flywheel 102 may not be in the top dead center position. While the flywheel 102 is not in the top dead center position, the pin 204 is in retracted position. In the retracted position, the first end 304 of the pin 204 is urged to make sliding contact with the portion 402 of the flywheel 102. This is due to the resilient push provided by the resilient member 206. The flywheel 102 is then selectively rotated to reach the top dead center position. As the flywheel 102 reaches the top dead center position, the resilient member 206 urges the pin 204 to be in the extended position. In the extended position, the first end 304 of the pin 204 engageably retains the flywheel 102 through the aperture 120 in the flywheel 102, to lock the flywheel 102 in the top dead center position.

It should be understood that the above description is intended for illustrative purposes only and is not intended to limit the scope of the present disclosure in any way. Those skilled in the art will appreciate that other aspects of the disclosure may be obtained from a study of the drawings, the disclosure, and the appended claim.

What is claimed is:

1. A timing pin module having a mount end and an engagement end, the timing pin module designed to mount on an engine for establishing a top dead center position of a crankshaft within the engine, the engine having an housing cover and a flywheel, the housing cover of the engine having an aperture to receive the timing pin module therein, the flywheel having an aperture to receive the engagement end of the timing pin module to lock the flywheel and the crankshaft in the top dead center position as the flywheel is selectively rotated therein, the timing pin module comprising:
an adapter disposed on the mount end of the timing pin module and having a through hole, the adapter being mountable to the housing cover of the engine within the aperture of the housing cover thereof;
a pin having a longitudinal axis, a first end disposed on the engagement end of the timing pin module, and a second end disposed on the mount end of the timing pin module, the pin being slideably disposed within the through hole of the adapter and being adapted to move between a retracted position and an extended position, the pin having a flywheel retention portion disposed on the first end of the pin; and
a resilient member having a first end engaged with the pin and a second end in engagement with the adapter, the first end of the pin being urged away from the adapter through the resilient member;
wherein the first end of the pin engageably retains the flywheel through the aperture in the flywheel to establish the top dead center position of the crankshaft coinciding with the pin being in the extended position,
wherein the first end of the pin being urged in slidable contact with a portion of the flywheel by the resilient member coinciding with the pin being in the retracted position in response to selective rotation of the flywheel and the flywheel and the crankshaft not in the top dead center position.
